(19) United States
(12) Patent Application Publication
(10) Pub. No.: US 2022/0009243 A1
(43) Pub. Date: Jan. 13, 2022

(54) PRINT MATERIAL LEVEL SENSING

(71) Applicant: Hewlett-Packard Development Company, L.P., Spring, TX (US)

(72) Inventors: Evan Clay Dagg, Corvallis, OR (US); Daryl E Anderson, Corvallis, OR (US); James Michael Gardner, Corvallis, OR (US)

(21) Appl. No.: 16/769,044

(22) PCT Filed: Apr. 5, 2019
(86) PCT No.: PCT/US2019/026105

§ 371 Date: Jun. 2, 2020

(51) Int. Cl. B41J 2/175; G01F 25/00; G01F 23/24

(52) U.S. Cl. CPC B41J 2/17566; G01F 23/247; G01F 25/0061

(57) ABSTRACT

A print material level sensor comprises a series of print material level sensing devices disposed at intervals to detect presence of a print material at successive depth zones in a container, wherein each print material level sensing device includes a heater to emit heat at its depth zone and a sensor to sense heat at the depth zone and to output a signal based on the heat sensed. The sensor has control circuitry to, for each print material level sensing device to be calibrated, turn on the heater for an initial time duration set by an initial heat count and iteratively adjust the time duration for which the heater is turned on in accordance with an adjusted heat count, until the signal output from the sensor indicates that a target value has been reached in that depth zone.

### BACKGROUND

Printing devices eject print material to form an image or structure. The print material may be stored in a container from which it is drawn by the printing device for ejection. Over time, the level of print material in the container is reduced. A print material level sensor is useful to determine a current level of print material.

### BRIEF DESCRIPTION OF DRAWINGS

Examples will now be described, by way of non-limiting example, with reference to the accompanying drawings, in which:

FIG. 1 shows an example print material level sensor;

FIG. 2 shows an example series of print material level sensing devices;

FIG. 3 shows measurement results of ink level sensing;

FIGS. 4A and 4B show example signal decay after heating has been stopped;

FIG. 5 shows example control circuitry;

FIG. 6 shows example control circuitry;

FIG. 7 shows example control circuitry;

FIG. 8 shows example control circuitry;

FIG. 9 shows an example calibration process;

FIG. 10 shows an example calibration process;

FIG. 11 shows example print material level sensing;

FIG. 12A shows an example print material container;

FIG. 12B shows an example print material level sensor and example electrical connection pads;

FIGS. 13A to 13C show example series of print material level sensing devices.

### DETAILED DESCRIPTION

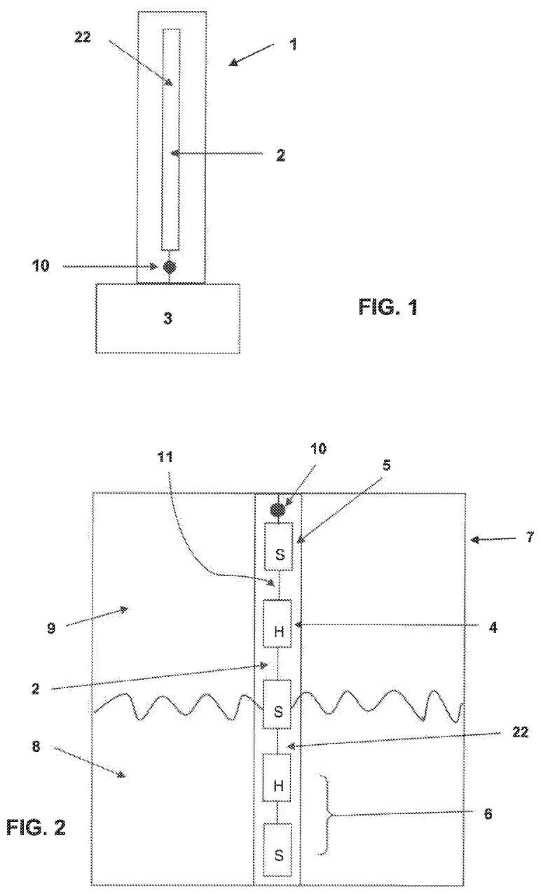

FIG. 1 shows an example print material level sensor 1. The example print material level sensor 1 includes a series 2 of print material level sensing devices and control circuitry 3. The series of print material level sensing devices 2 receive electrical power from a node 10. The node 10 receives the electrical power from a power source.

FIG. 2 shows an example of part of a series 2 of print material level sensing devices. In the example of FIG. 2, a pair of a heater 4 and a sensor 5 form a print material level sensing device 6. In this way, the series of print material level sensing devices are disposed at intervals to detect presence of the print material at successive depth zones within a volume 7. The volume 7 is shown partially filled with a print material 8. The remainder of the volume may be filled with a gas such as air 9. The extent to which the volume is filled by the print material will vary over time as print material is used in printing by a printing device. The extent to which the volume is filled will also change if the print material in the volume is replenished. Example print materials may include any of ink, for example dye based ink or pigment based ink, fixer, for example to bind ink, a primer, for example for an undercoating, a finish, for example for a coating, a fusing agent, for example for use in three-dimensional printing, and a detailing agent, for example for use in three-dimensional printing. Also, suitable print materials may for example include materials which can be titrated for use in life sciences applications

The heater 4 of a print material level sensing device 6 emits heat at its depth zone and the sensor 5 senses heat at the depth zone to output a signal based on the heat sensed. The sensor 5 is sufficiently close to the heater 4 to sense heat when the heater is emitting heat. Wiring 11 enables to supply electrical power to the heaters 4 in the series 2 from a node 10. Wiring 11 may for example be in the form of metal traces, such as thin film metal traces, that transmit power from the power source to the heaters. The metal traces may be formed on the carrier by a silicon CMOS fabrication process. The metal traces may for example comprise aluminium. As an example, a metal trace may have a width of no greater than 100 μm and a length of at least 10,000 μm.

Control circuitry 3 enables calibration of the print material level sensing devices to be performed. The control circuitry may, for each print material level sensing device to be calibrated, turn on the heater for an initial time duration set by an initial heat count and iteratively adjust the time duration for which the heater is turned on in accordance with an adjusted heat count, until the signal output from the sensor indicates that a target value has been reached in that depth zone.

By performing calibration in this manner, for each print material level sensing device a heat count can be determined for which the sensor output gives a desired target value. By determining the heat count, the associated time duration for which the heater 4 of the print material level sensing device 6 is to be turned on during subsequent sensing is also determined. Accordingly, a heat count, and hence time duration for turning on the heater during print material level sensing, can be determined for each individual print material level sensing device. During subsequent print material level sensing by the print material level sensor, the heater of each print material level sensing device can then be turned on for the time duration that was determined for that heater during calibration. In one example, the calibration is performed when the volume 7 is expected to be filled with print material 8. In other words, when it is expected that each of the print material level sensing devices is submerged below the upper surface of the print material in the container. This may for example be when a print material container, containing print material and having a print material level sensor therein, is first connected to a printer device.

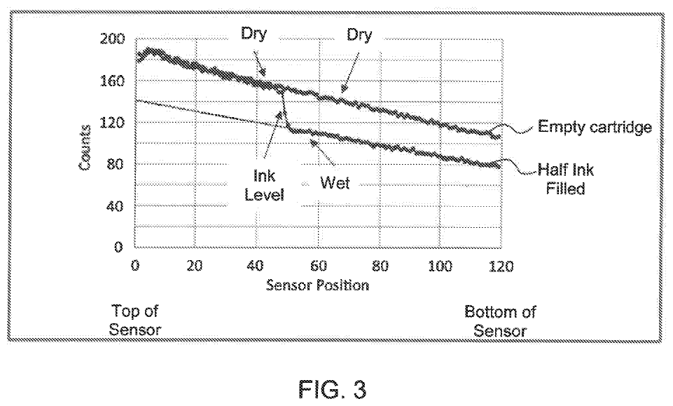

FIG. 3 shows measurement results obtained from a print material level sensor which has not been calibrated as described above. FIG. 3 shows measurement results from sensor 0 to sensor 120 of a series of print material level sensing devices. The data of FIG. 3 was, in contrast to the description above, obtained by heating each heater for a same predetermined amount of time. The sensors are plotted along the x axis from the sensor 0 at a top position to the sensor 120 at a bottom position. In this arrangement, the sensor 0, and its associated heater, heater 0, is closest to the power source powering the heaters. The sensor 120, and its associated heater, heater 120, is furthest from the power source powering the heaters. The y axis shows a measured value of the signal output by each sensor. The measured value is obtained from the sensor by turning on its associated heater for the predetermined amount of time, turning off the heater, waiting for a fixed delay amount to expire, and then measuring the signal.

In FIG. 3, the upper line of results are when air is present around all of the sensors from sensor 0 at the top to sensor 120 at the bottom. In other words, the container is empty and no print material is present. The lower line of results are when print material, in this example ink, is present from the bottom sensor 120 up to around sensor 50. Above around sensor 50, i.e. from there up to sensor 0, air is present. The step change in the lower line of results shows the transition from print material to air. It therefore shows the level, hence the amount, of print material present in the container.

It can further be seen from FIG. 3 that the upper line of results has a slope from the sensor 0 position at the left-hand side of the graph to the sensor 120 position at the right-hand side of the graph. For the sensor 0 a measured count value of over 180 is measured whereas for the sensor 120 a measured count value of over 100 is measured. Thus, the measured value decreases as the sensor position becomes further from the top and closer to the bottom.

The lower line of results demonstrates a similar slope, both in the region at which air is present and in the region in which print material is present. The dashed line shows how the slope in the region in which print material is present would continue if print material were to be present all the way up to the sensor 0 position. It can be seen that the difference in measured value depending on which of air and print material is present at the sensor 0 position is significantly higher than the difference in measured value depending on which of air and print material is present at the sensor 120 position. The sensitivity with which the presence of air and print material can be determined is therefore greater at the sensor 0 position than at the sensor 120 position.

It has been determined by the inventors that the decrease in measured value is due to parasitic voltage drops suffered by the heaters of the print material level sensing devices as the distance from the power source increases. The narrow carrier on which the series of print material level sensing devices may be provided and the narrow wiring that transmits electrical power to the print material level sensing devices from the node contribute to the parasitic voltage drops. As a result of the parasitic voltage drops, heaters further away from the power source receive less power in a given amount of time than heaters closer to the node and hence to the power source. A cause of the parasitic voltage drop in the wiring is the narrowness of the wiring and the thickness it can be fabricated to. In other words, the wiring having a width much smaller than its length. For a heater further from the power source the length of the wiring is greater than for a heater closer to the power source and hence the parasitic voltage drop is greater. As outlined above, the wiring may for example be in the form of metal traces, such as thin film metal traces. As an example, a metal trace may have a width of no greater than 100 μm and a length of at least 10,000 μm.

In contrast to the measurement results shown in FIG. 3, the example calibration described above enables, during subsequent level sensing, that a heater of each print material level sensing device can be supplied with electrical power for a time duration determined for that print material level sensing device to obtain a target value in the signal output by the sensor of the print material level sensing device. As an example, by using the same target value for each print material level sensing device during calibration, it can be enabled that subsequent measurement can be performed from a same or similar starting temperature at each print material level sensing device irrespective of the depth zone at which the print material level sensing device is located. A same or similar sensitivity can thereby be achieved for each print material level sensing device and an undesirable reduction in signal to noise ratio (SNR) can be avoided, enabling more accurate determination of the remaining amount of print material. In an example arrangement in which the topmost sensor is closest to the node, and hence to the power source, and the bottommost sensor is furthest from the node, the remaining amount of print material can be accurately determined as the container approaches an empty state.

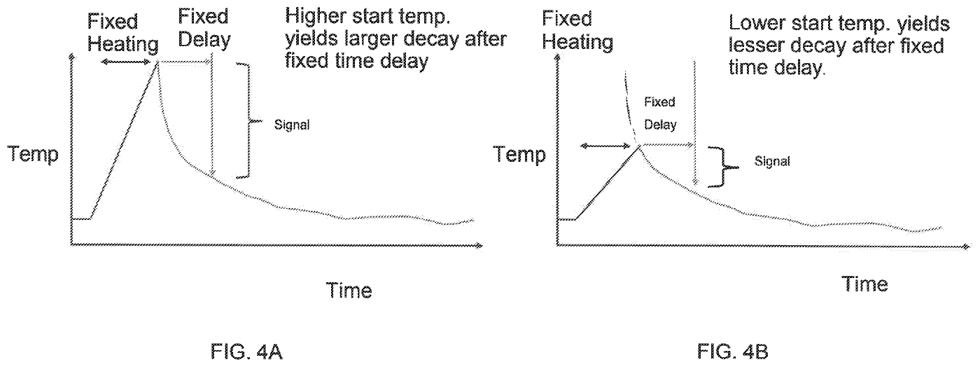

FIGS. 4A and 4B show an effect of heating a heater at a depth zone to obtain a higher starting temperature before performing measurement. If for example a measurement is made after a fixed delay time has been reached from when heating is stopped, then for a higher starting temperature a larger decay in the sensed signal may occur during the delay time. This provides more degrees of discrimination versus a depth zone that is decaying from a lower starting temperature. The circuitry therefore has a larger dynamic range to work with. The rate of decay from the starting temperature will vary depending on the heat capacity of the material present around the sensor, whereby which of print material and air is present can be determined.

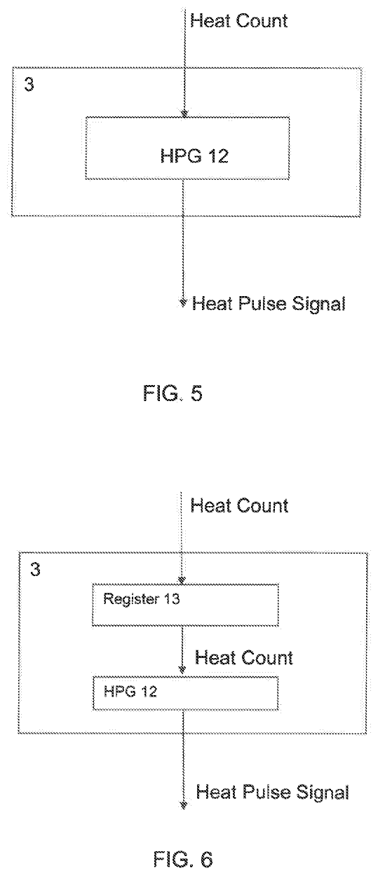

Turning again to the example of FIGS. 1 and 2, in one example the control circuitry 3 may have a heat pulse generator 12 as shown in FIG. 5 to receive the initial heat count and to output a heat pulse signal to turn on the heater 4 for the initial time duration in accordance with the initial heat count.

In an example, the heat pulse generator 12 may further receive the adjusted heat count and output a heat pulse signal to turn on the heater for an adjusted time duration in accordance with the adjusted heat count. This can be repeated thereafter for new adjusted heat counts until the value of the sensor output signal reaches the target value.

As a further example, the control circuitry 3 may have a memory such as a register 13 to hold the initial heat count to be inputted to the heat pulse generator 12. The register may then receive and hold an adjusted heat count to be inputted to the heat pulse generator. The register may receive a plurality of successive adjusted heat counts. The register may overwrite the previously held heat count with the new heat count when it receives a new heat count. The register may output the currently held heat count to the heat pulse generator for the heat pulse generator to generate a heat pulse signal in accordance with that heat count. An example of control circuitry having a register is shown in FIG. 6.

In one example of the print material level sensor, the control circuitry first calibrates a print material level sensing device at a depth zone closer to a power node and then calibrates print material level sensing devices at depth zones successively further away from the power node. In one example, the memory, such as the register 13 may for example hold the adjusted heat count at which the target value is reached for the previously calibrated print material level sensing device as the initial heat count of the next print material level sensing device to be calibrated.

In one example, the heat count may have at least one of a minimum heat count value which the heat count cannot be reduced below and a maximum heat count value which the heat count cannot be increased above. As a consequence, there may be a minimum time duration for which a heater can be turned on and a maximum time duration for which a heater can be turned on. This may enable to avoid insufficient heating occurring or the calibration or subsequent level sensing from taking too long or damaging the device.

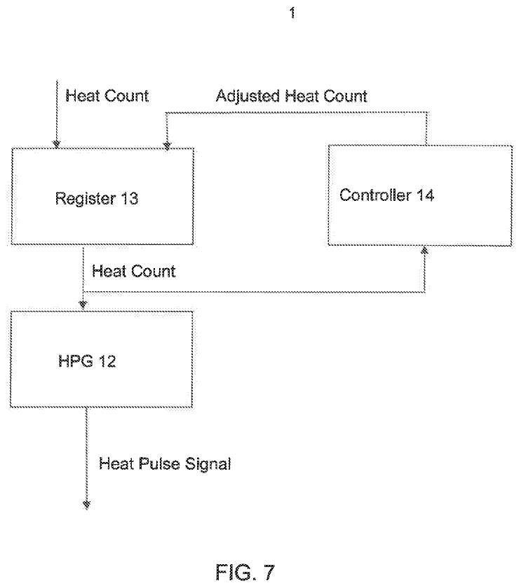

In a further example, a controller 14 such as a microcontroller, CPU, processing unit, may adjust the heat count and provide the adjusted heat count to the register 13 as shown in FIG. 7. As another example, the controller 14 may provide the adjusted heat count directly to the heat pulse generator 12. As an example, the controller may determine the adjusted heat count based on the heat count and the signal output by the sensor. For example, the controller may compare a value of the signal output by the sensor to a target value and adjust the heat count based on the difference.

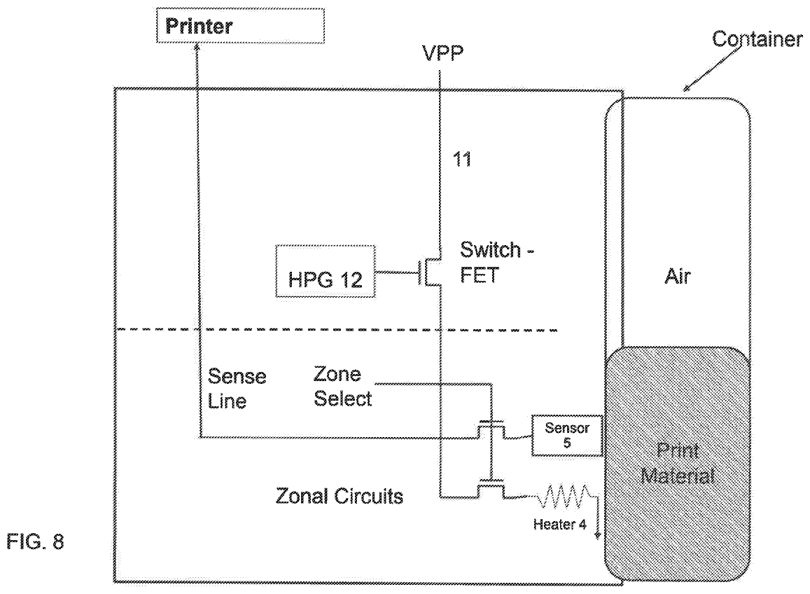

In one example, the heat pulse signal generated by the heat pulse generator may control a switch to turn on the heater of the print material level sensing device in the selected zone. An example is shown in FIG. 8. Here the heat pulse signal generated by the heat pulse generator controls a switch to provide electrical power through the wiring 11 to the heater 4 of the print material level sensing device in the selected zone. For example, the switch may be a field-effect transistor (FET) which can be enabled by the heat pulse signal. In FIG. 8, a single heater 4 and sensor 5 are depicted for simplicity. It will be appreciated that each heater 4 and sensor 5 is similarly connected to the control circuitry.

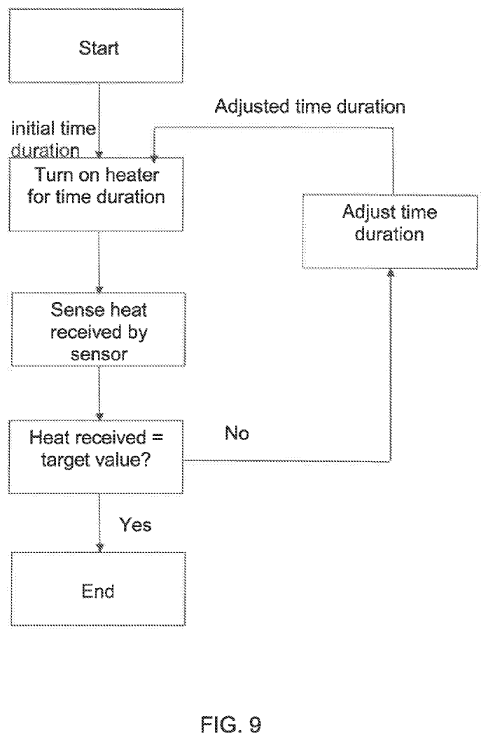

FIG. 9 shows an example calibration process for a print material level sensing device. An initial time duration is used to turn on the heater of the print material level sensing device. The initial time duration may for example be indicated by a heat count. The heat received by the sensor of the print material level sensing device is sensed by the sensor. The value of the signal output by the sensor can be compared to a target value. If the value of the output signal does not equal the target value, the time duration may be adjusted. The time duration may be increased if the value of the output signal is below the target value. The time duration may be decreased if the value of the output signal is above the target value. The adjustment may be of a heat count indicating the time duration. The heater is then turned on for the adjusted time duration, based for example on the adjusted heat count. The process may be repeated until the value of the signal output by the sensor equals the target value. In one example, the value of the signal output by the sensor may be considered to equal the target value if it falls within a given range of the target value. As an example, the heat count at which the value of the signal output by the sensor equals the target value may be stored in a memory. For example, it may be stored in a non-volatile memory of a print material container in which the print material level sensor is provided. As an example, the non-volatile memory may be part of the ink level sensor.

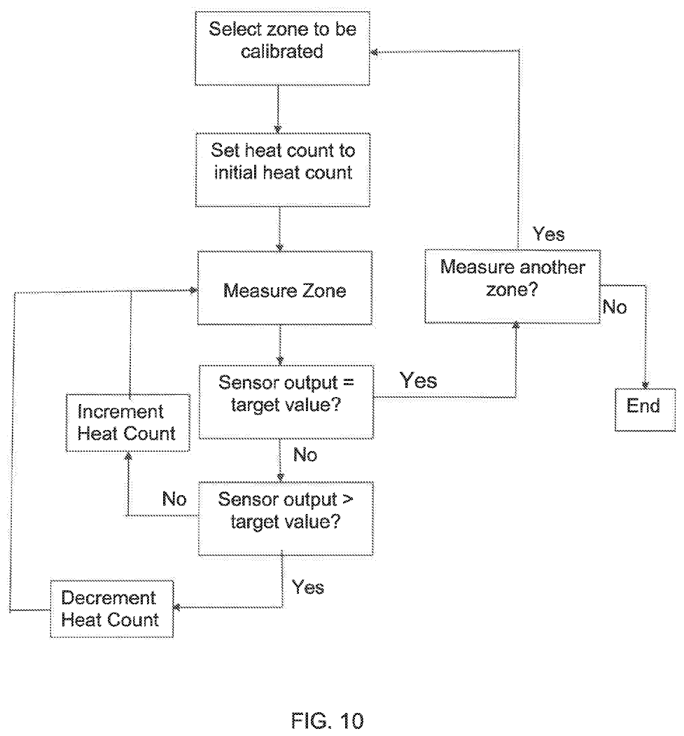

FIG. 10 shows another example calibration process. In this example process, a print material level sensing device to be calibrated is selected. This may for example be in accordance with a zone select signal. The zone select signal may be received from an external device such as a printer or may for example be generated or otherwise obtained by the control circuitry 3. An initial heat count for the selected zone may be set. The initial heat count may be received by control circuitry 3 from an external device such as a printer or may for example be generated or obtained by a controller 14. The initial heat count may be input into a memory such as register 13 or directly into a heat pulse generator 12. The heater 4 of the selected print material level sensing device 6 may be turned on for a time duration indicated by the initial heat count. The sensor of the print material level sensing device senses heat received. A value of the signal output by the sensor may be compared to a target value. If the value of the signal output by the sensor does not equal the target value then an adjustment may be made to the heat count. The value of the signal output by the sensor may be considered as equaling the target value if it falls within a given range of the target value. To determine any adjustment to the heat count, it is determined whether the value output by the sensor is greater than or less than the target value. If greater than the target value, then the heat count will be decremented. If less than the target value, then the heat count will be incremented. The magnitude by which the heat count is decremented or incremented may depend on the magnitude of the difference between the value of the signal output by the sensor and the target value. The heater of the selected print material level sensing device may then be turned on for a time duration indicated by the adjusted heat count. The process may be repeated until the value of the signal output by the sensor equals the target value. If it is determined that the signal output by the sensor equals the target value, it may be determined whether to calibrate another of the print material level sensing devices. If another print material level sensing device is to be calibrated, the calibration process is repeated for that device. As an example, the calibration process may be repeated until each of the print material level sensing devices has been calibrated. For a calibrated print material level sensing device, the heat count at which the value of the signal output by the sensor equals the target value may be stored. For example, the heat count may be outputted to a memory or external device such as a printer for storage. As an example, the heat count may be stored in a non-volatile memory provided to a print material container in which the print material level sensor is provided. As an example, the non-volatile memory may be part of the ink level sensor. By storing the calibration values in a non-volatile memory of the container, the values can be maintained even if the supply of electrical power to the container is stopped. For example, if the container is attached to a printer and is powered down. The calibration values can then be maintained even if, for example, the container is removed from the printer and connected to another printer.

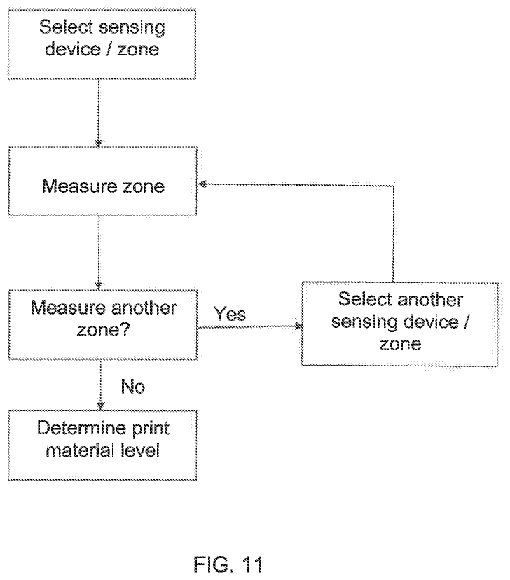

FIG. 11 shows an example of print level sensing after calibration has been performed. In this example, a print material level sensing device is selected and the heat count obtained during calibration for that print material level sensing device is set. Measurement is then performed by heating the heater of that device and sensing using the sensor of that device. After measurement has been performed, a determination is made as to whether measurement should be performed at another zone. For example, it may be determined to perform measurement for another zone until measurement has been performed for all zones. If measurement is to be performed at another zone, the sensor for that zone is selected and the heat count for that zone as determined during the calibration is set. Heating and sensing is then performed by the print material level sensing device of that zone. After measurement of the zones has been completed, in other words when a determination is made not to measure any other zones, the data obtained from the measurements can be used to determine the level of the print material present.

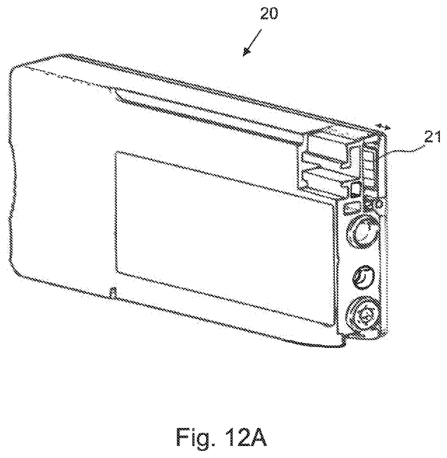

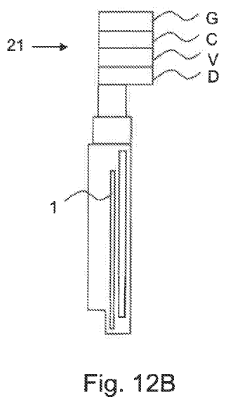

FIG. 12A shows an example print material container 20 having a print material level sensor therein. The print material container 20 includes electrical connection pads 21 to connect to an electrical connector of a printer. The electrical connection pads 21 are also connected to the print material level sensor provided within the container 20. An example of a print material level sensor 1 and electrical connection pads 21 is shown in FIG. 12B. In this example, four electrical connection pads, namely a ground connection pad G, a serial clock connection pad C, a supply voltage connection pad V and a serial data input/output pad D are provided. More or fewer pads may be provided. The electrical connection pads may form a communication bus protocol, for example an I²C data interface for communication with the printer. The electrical connection pads may enable communication of signals and electrical power between the printer and the print material level sensor.

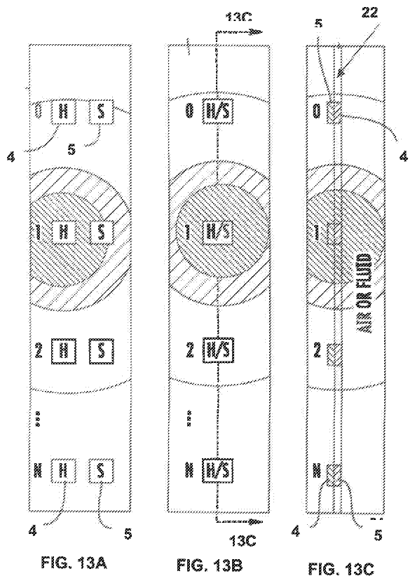

FIG. 2 described above shows one example of a series of print material level sensing devices. Further examples of a series of print material level sensing devices are shown in FIGS. 13A to 13C. In the example of FIG. 13A, heaters 4 and sensors 5 are arranged in pairs labelled 0, 1, 2, . . . N. Thus, the heaters and sensors are arranged in an array of side-by-side pairs. Each pair is a print material level sensing device 6.

In the example of FIG. 13B, heaters 4 and sensors 5 are arranged in an array of stacks vertically spaced. FIG. 13C is a sectional view of FIG. 13B further illustrating the stacked arrangement of the pairs of heaters 4 and sensors 5 forming the print material level sensing devices 6.

In the above described examples, a heater of a print material level sensing device may include an electrical resistor. As an example, a heater may have a heating power of at least 10 mW. As a further example, a heater may have a heating power of less than 10 W. A sensor may include a diode which has a characteristic temperature response. For example, in one example, a sensor may include a P-N junction diode. In other examples, other diodes may be employed or other thermal sensors may be employed. For example, a sensor may include a resistor such as a metal thin film resistor. The resistor may for example be located between the heater and the print material, for example by forming the resistor above the heater in a fabrication stack.

In the above described examples, a sensor of a print material level sensing device is sufficiently close to the associated heater to sense heat when the heater emits heat. For example, the sensor may be no greater than 500 μm from the heater. In a further example, the sensor may be no greater than 20 μm from the heater. As one example, the sensor may be a metal thin film resistor layer formed less than 1 μm above a heater resistor layer in a fabrication stack. In such an example, the sensor resistor layer and the heater resistor layer may be separated by a dielectric layer.

In the above described examples, there may be at least five print material level sensing devices in the print material level sensor. As a further example there may be at least ten print material level sensing devices. As a still further example, there may be at least twenty print material level sensing devices. For example, there may be at least one hundred print material level sensing devices.

In the above described examples, the heaters and sensors may be supported on an elongated strip. A strip 22 is shown in FIGS. 1, 2 and 13C. The strip may comprise silicon. The strip may have an aspect ratio, which is a ratio of its length/width, of at least 20.

To supply electrical power received from a power source to each of the heaters 4 wiring 11 may be provided. As outlined above, the wiring 11 may be in the form of one or more metal traces, such as thin film metal traces, that transmit power from the power source to the heaters. The metal traces may be formed, for example on the strip, by a silicon CMOS fabrication process. The metal traces may for example comprise aluminium. As an example, a metal trace may have a width of no greater than 100 μm. The metal trace may have a length which is at least one hundred times greater than its width. As an example, the metal trace may have a length of at least 10,000 μm.

FIGS. 13A to 13C additionally illustrate an example of pulsing of a heater 4 of a print material level sensing device 6, and the subsequent dissipation of heat through the adjacent materials. In FIGS. 13A to 13C, the intensity of the heat declines further away from the source of the heat, i.e. the heater 4 of the print material level sensing device 6. The dissipation of heat is illustrated by the change of crosshatching in FIGS. 13A to 13C.

While apparatus, method and related aspects have been described with reference to certain examples, various modifications, changes, omissions, and substitutions can be made without departing from the spirit of the present disclosure. It is intended, therefore, that the apparatus, method and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, and “a” or “an” does not exclude a plurality.

The features of any dependent claim may be combined with the features of any of the independent claims or other dependent claims.

1. A print material level sensor comprising:
a series of print material level sensing devices disposed at intervals to detect a presence of a print material at successive depth zones in a container, wherein each print material level sensing device includes a heater to emit heat at its depth zone and a sensor to sense heat at the depth zone and to output a signal based on the heat sensed; and
control circuitry to, for each print material level sensing device to be calibrated, turn on the heater for an initial time duration set by an initial heat count and iteratively adjust the time duration for which the heater is turned on in accordance with an adjusted heat count, until the signal output from the sensor indicates that a target value has been reached in that depth zone.

2. The print material level sensor of claim 1, the control circuitry having a heat pulse generator to receive the initial heat count and to output a heat pulse to turn on the heater for the initial time duration in accordance with the initial heat count.

3. The print material level sensor of claim 2, the heat pulse generator to receive the adjusted heat count and to output a heat pulse to turn on the heater for an adjusted time duration in accordance with the adjusted heat count.

4. The print material level sensor of claim 2, the control circuitry having a register to hold the initial heat count to be inputted to the heat pulse generator.

5. The print material level sensor of claim 4, wherein the register receives an adjusted heat count to be inputted to the heat pulse generator.

6. The print material level sensor of claim 1, wherein the control circuitry first calibrates a print material level sensing device at a depth zone closer to a power node and then calibrates print material level sensing devices at depth zones successively further away from the power node.

7. The print material level sensor of claim 1, wherein the control circuitry includes a register that holds the adjusted heat count at which the target value is reached for the previously-calibrated print material level sensing device as the initial heat count of the next print material level sensing device to be calibrated.

8. The print material level sensor of claim 1, wherein the heat count has at least one of a minimum heat count value which the heat count cannot be reduced below and a maximum heat count value which the heat count cannot be increased above.

9. The print material level sensor of claim 1, wherein the control circuitry includes at least one of a counter to increment the heat count and a counter to decrement the heat count.

10. The print material level sensor of claim 1, wherein the control circuitry includes a comparator to compare a value of the signal outputted by the sensor to the target value.

11. The print material level sensor of claim 1, wherein the series of print material level sensing devices is provided on an elongated strip having an aspect ratio of at least 20.

12. A print material container comprising:
a chamber to hold a volume of print material;
a series of print material level sensing devices disposed at intervals to detect a presence of the print material at successive depth zones in the chamber, wherein each print material level sensing device includes a heater to emit heat at its depth zone and a sensor to sense heat at the depth zone and to output a signal based on the heat sensed; and
control circuitry to, for each print material level sensing device to be calibrated, turn on the heater for an initial time duration set by an initial heat count and iteratively adjust the time duration for which the heater is turned on in accordance with an adjusted heat count, until the signal output from the sensor indicates that a target value has been reached in that depth zone.

13. A method, comprising calibrating print material level sensing devices disposed at successive depth zones in a container holding a volume of print material, wherein the calibration includes, for each print material level sensing device to be calibrated:
turning on, for an initial time duration, a heater of the print material level sensing device to emit heat at the depth zone of that print material level sensing device;
sensing heat received by a thermal sensor at the depth zone of that print material level sensing device; and
iteratively adjusting the time duration for which the heater is turned on until a signal output by the thermal sensor indicates that a target value has been reached in that depth zone.

14. The method of claim 13, wherein print material level sensing devices are calibrated sequentially in order of depth zone from a depth zone closer to a power node to depth zones successively further away from the power node.

15. The method of claim 13, wherein each of the print material level sensing devices is submerged below an upper surface of the print material in the container.

16. The print material container of claim 12, the control circuitry having a heat pulse generator to receive the initial heat count and to output a heat pulse to turn on the heater for the initial time duration in accordance with the initial heat count.

17. The print material container of claim 12, wherein the control circuitry first calibrates a print material level sensing device at a depth zone closer to a power node and then calibrates print material level sensing devices at depth zones successively further away from the power node.

18. The print material container of claim 12, wherein the control circuitry includes a register that holds the adjusted heat count at which the target value is reached for the previously-calibrated print material level sensing device as the initial heat count of the next print material level sensing device to be calibrated.

19. The print material container of claim 12, wherein the heat count has at least one of a minimum heat count value which the heat count cannot be reduced below and a maximum heat count value which the heat count cannot be increased above.

20. The print material container of claim 12, wherein the control circuitry includes a comparator to compare a value of the signal outputted by the sensor to the target value.
